(19) United States
(12) Patent Application Publication
(10) Pub. No.: US 2013/0047638 A1
(43) Pub. Date: Feb. 28, 2013

(54) DRYER APPLIANCE WITH ACCELERATED REFRIGERANT CYCLE

(71) Applicants: Nicholas Okruch, JR., Mount Washington, KY (US); David Gardner Beers, Elizabeth, IN (US)

(72) Inventors: Nicholas Okruch, JR., Mount Washington, KY (US); David Gardner Beers, Elizabeth, IN (US)

(73) Assignee: GENERAL ELECTRIC COMPANY, Schenectady, NY (US)

(21) Appl. No.: 13/222,080

(22) Filed: Aug. 31, 2011

(51) Int. Cl. F26B 23/00; F25B 29/00

(52) U.S. Cl. 62/79; 34/86; 34/553

(57) ABSTRACT

An appliance heat pump dryer is provided that has an accelerated refrigerant cycle for providing heat to the articles being dried. The heat source, such as an electrical heating element, provides heat to the evaporator so that the appliance can reach steady state operating conditions more rapidly and thereby reduce the overall cycle operating time. Options can be provided for the user to select whether the drying cycle will be accelerated.

### FIELD OF THE INVENTION

The subject matter of this application relates to a dryer appliance having a refrigerant cycle for providing heat to articles for drying.

### BACKGROUND OF THE INVENTION

A conventional appliance for drying articles such as a clothes dryer (or laundry dryer) for drying clothing articles typically includes a cabinet having a rotating drum for tumbling clothes and laundry articles therein. One or more heating elements heats air prior to the air entering the drum, and the warm air is circulated through the drum as the clothes are tumbled to remove moisture from laundry articles in the drum. Gas or electric heating elements may be used to heat the air that is circulated through the drum.

In a known operation, ambient air from outside is drawn into the cabinet and passed through the heater before being fed to the drum. Moisture from the clothing is transferred to the air passing through the drum. Typically, this moisture laden air is then transported away from the dryer by e.g., a duct leading outside of the structure or room where the dryer is placed. The exhausted air removes moisture from the dryer and the clothes are dried as the process is continued by drawing in more ambient air.

Unfortunately, for the conventional dryer described above, the exhausted air is still relatively warm while the ambient air drawn into the dryer must be heated. This process is relatively inefficient because heat energy in the exhausted air is lost and additional energy must be provided to heat more ambient air. More specifically, the ambient air drawn into the dryer is heated to promote the liberation of the moisture out of the laundry. This air, containing moisture from the laundry, is then exhausted into the environment along with much of the heat energy that was used to raise its temperature from ambient conditions.

One alternative to a conventional dryer as described above is a heat pump dryer. More specifically, a heat pump dryer uses a refrigerant cycle to both provide hot air to the dryer and to condense water vapor in air coming from the dryer. Because the moisture content in the air from the dryer is reduced by condensation over the evaporator, this same air can be reheated again using the condenser and then passed through the dryer again to remove more moisture. Because the air is recycled through the dryer in a closed loop rather than being ejected to the environment, the heat pump dryer can be more efficient to operate than the traditional dryer described above. In addition, the heating source provided by the sealed refrigerant system of a heat pump dryer can be more efficient than a gas or electric heater implemented in the conventional dryer.

The efficiency and capacity of the heat pump dryer is increased when the operating temperature of the evaporator is above ambient temperature. However, when the heat pump dryer first begins operation after being at ambient conditions, a transient start-up period occurs over which the dryer—more particularly its refrigerant cycle—must operate before reaching steady state operating conditions. During this transient start-up, the dryer operates less efficiently as the evaporator cools down and the condenser heats up to provide hot air for the dryer. The efficiency of the compressor is also less during this transient period and continues until the evaporator and condenser reach operating temperatures that are above ambient. In addition to having less efficiency, this transient start-up period increases the overall cycle time for drying clothes or other articles—additional time that may be disfavored by the user of the appliance.

Accordingly, a heat pump dryer having improved efficiency over conventional, electrical or gas heating element based dryers would be useful. In addition, such a heat pump dryer that can more rapidly reach steady state operating conditions would be beneficial. A heat pump dryer that can also have an overall reduced cycle time for drying articles such as clothing would be particularly useful.

### BRIEF DESCRIPTION OF THE INVENTION

Aspects and advantages of the invention will be set forth in part in the following description, or may be obvious from the description, or may be learned through practice of the invention.

In one exemplary embodiment, the present invention provides a laundry dryer that includes a drum for receipt of a load of articles for drying and a refrigerant based heating system. The refrigerant based heating system includes a compressor for pressurizing a refrigerant; a gas cooler for cooling refrigerant from the compressor and heating air provided to the drum; an evaporator for vaporizing refrigerant and cooling and dehumidifying air from the drum; and an expansion device for reducing the pressure of refrigerant received from the condenser. A heating element is attached to the evaporator. The heating element is configured for raising the temperature of refrigerant flowing through the evaporator.

In another exemplary aspect, the present invention provides a method of operating a heat pump dryer. The heat pump dryer has a refrigerant cycle that includes an evaporator and a gas cooler through which a refrigerant is cycled. The method includes the steps of applying heat to the evaporator using a heating element positioned to provide heat by thermal conduction to the evaporator; raising the temperature, pressure, or both of the refrigerant using the heating element; and, reducing or terminating the application of heat to the evaporator from the heating element once the temperature, pressure, or both of the refrigerant reaches a certain predetermined level.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 provides a perspective view of an exemplary embodiment of a heat pump dryer of the present invention.

FIG. 2 provides another perspective view, with a portion of the cabinet removed, of the heat pump dryer of FIG. 1.

FIG. 3 provides a schematic view of the refrigerant cycle for a heat pump dryer according to an exemplary aspect of the present invention.

### DETAILED DESCRIPTION OF THE INVENTION

The present invention relates to an appliance heat pump dryer having an accelerated refrigerant cycle for providing heat to the articles. The heat source, such as an electrical heating element, provides heat to the evaporator so that the appliance can reach steady state operating conditions more rapidly and thereby reduce the overall cycle operating time. Options can be provided for the user to select whether the drying cycle will be accelerated.

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the term “article” may refer to but need not be limited to fabrics, textiles, garments (or clothing), and linens. Furthermore, the term “load” or “laundry load” refers to the combination of articles that may be washed together in a washing machine or dried together in a laundry dryer (i.e. clothes dryer) and may include a mixture of different or similar articles of different or similar types and kinds of fabrics, textiles, garments and linens within a particular laundering process.

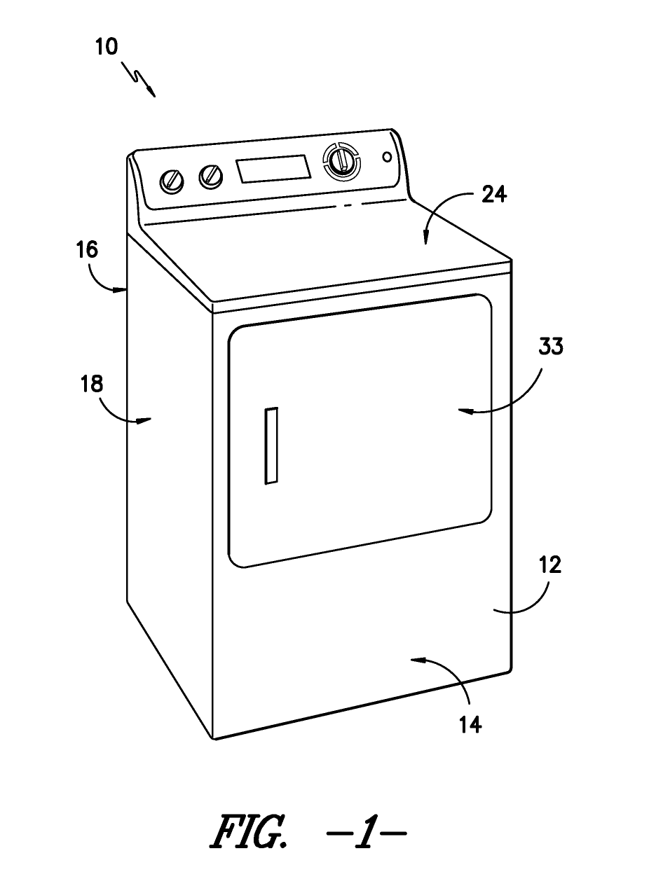

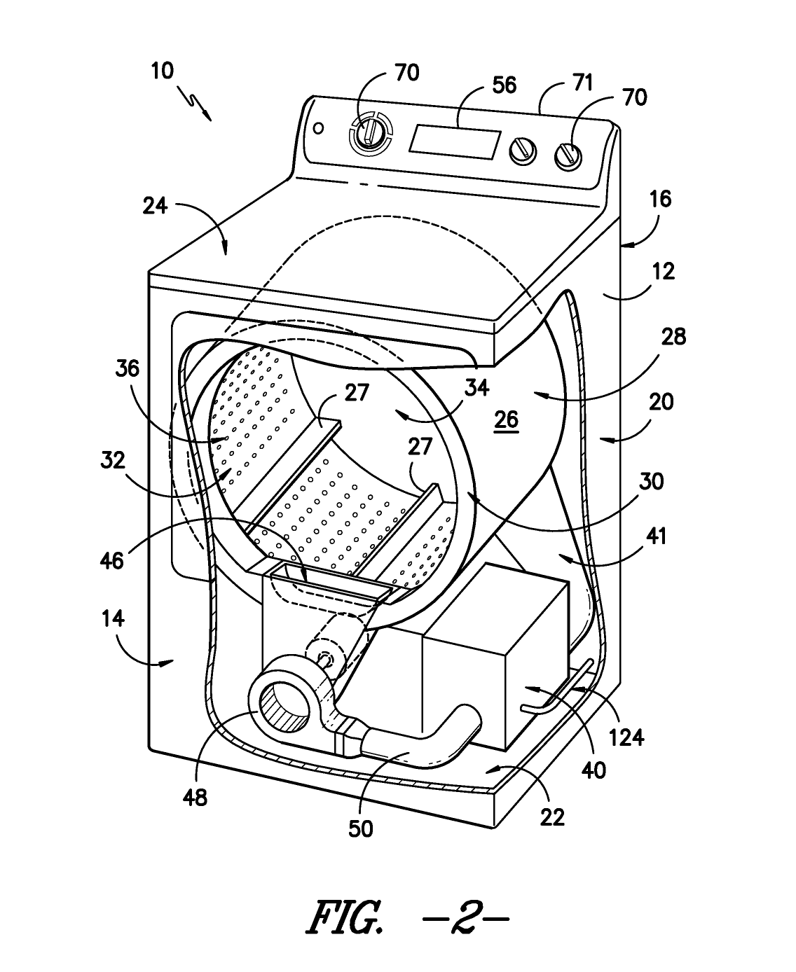

FIGS. 1 and 2 illustrate an exemplary embodiment of a heat pump dryer appliance 10 of the present invention. While described in the context of a specific embodiment of a clothes dryer 10, using the teachings disclosed herein it will be understood that dryer 10 is provided by way of example only. Other heat pump dryers having a different appearance and different features may also be utilized with the present invention as well.

Dryer 10 includes a cabinet or a main housing 12 having a front panel 14, a rear panel 16, a pair of side panels 18 and 20 spaced apart from each other by front and rear panels 14 and 16, a bottom panel 22, and a top cover 24. Within cabinet 12 is a drum or container 26 mounted for rotation around a substantially horizontal axis. A motor (not shown) rotates the drum 26 about the horizontal axis through a pulley and a belt (not shown). The drum 26 is generally cylindrical in shape, having an imperforate outer cylindrical wall 28 and a front flange or wall 30 defining an opening 32 of drum 26 for loading and unloading of clothing articles and other fabrics. Outer cylindrical wall 28 could also be perforated as well in other embodiments of the invention.

A plurality of tumbling ribs 27 are provided within drum 26 to lift clothing articles therein and then allow them to tumble back to the bottom of drum 26 as drum 26 rotates. Drum 26 includes a rear wall 34 rotatably supported within main housing 12 by a suitable fixed bearing. Rear wall 34 can be fixed or can be rotatable. Rear wall 34 includes a plurality of holes 36 that receive hot air that has been heated by a heat pump or refrigerant based heating system 40—to be described further below. Moisture laden, heated air is drawn from drum 26 by a blower fan 48. The air passes through a screen filter 46 which traps lint particles. As the air passes from blower fan 48, it enters a duct 50 and then is passed into heating system 40. Heated air (with a lower moisture content than was received from drum 26), exits heating system 40 and returns to drum 26 by duct 41. After the clothing articles have been dried, they are removed from the drum 26 via opening 32. A door 33 provides for closing or accessing drum 26 through opening 32.

A cycle selector knob 70 is mounted on a cabinet backsplash 71 and is in communication with a processing device or controller 56. Signals generated in controller 56 operate the drum drive system and heating system in response to the position of selector knobs 70. Alternatively, a touch screen type interface may be provided. As used herein, “processing device” or “controller” may refer to one or more microprocessors or semiconductor devices and is not restricted necessarily to a single element. The processing device can be programmed to operate dryer 10 according to the exemplary aspects of the present invention as set forth below. The processing device may include, or be associated with, one or memory elements such as e.g., electrically erasable, programmable read only memory (EEPROM).

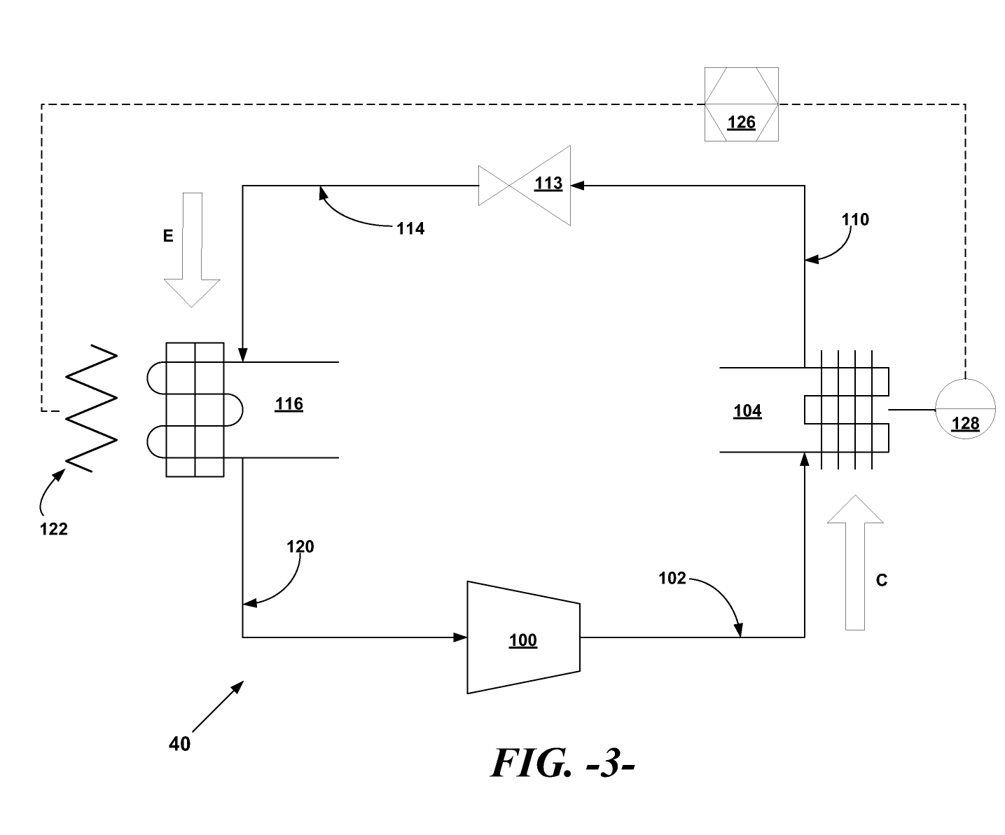

FIG. 3 is a schematic representation of an exemplary embodiment of a refrigerant based heating system 40 as may be used with clothes dryer 10. During steady state operating conditions, moisture laden air (arrow E), heated by gas cooler 104 and received from drum 26 is caused to flow across an evaporator 116, where the temperature of the air is reduced through heat exchange with refrigerant that is vaporized within e.g., coils or tubing of evaporator 116. This vaporization process absorbs both the sensible and the latent heat from the moisture laden air—thereby reducing its temperature. As a result, moisture in the air is condensed and is drained out using line 124 (FIG. 2).

Air passing over evaporator 116 becomes drier and cooler than when it was received from drum 26 of dryer 10. As shown by arrow C, the air from evaporator 116 is subsequently caused to flow across gas cooler 104 e.g., across coils or tubing). As used herein, it should be understood that the term “gas cooler” also includes one or more condensers and other heat exchangers for cooling and/or condensing the refrigerant. The refrigerant in gas cooler 104 is in a gaseous state at a relatively high temperature compared to the air from evaporator 116. As a result, heat energy is transferred to the air—thereby elevating its temperature and providing warm air for resupply to the drum 26 of dryer 10. Because the same air is recycled through drum 26 and heating system 40, dryer 10 can have a much greater efficiency than traditional clothes dryers where warm, moisture laden air is exhausted to the environment.

Continuing with FIG. 3, refrigerant based heating system 40 includes a compressor 100 that pressurizes refrigerant—i.e. increases the pressure of the refrigerant supplied by suction line 120. Compressor 100 is designed to pressurize a gas phase refrigerant. Accordingly, in order to avoid damage, it is important that refrigerant in suction line 120 is all supplied in a gas phase. The pressurization of the refrigerant with compressor 100 increases the temperature of the refrigerant. Accordingly, by line 102, the compressed refrigerant is fed to gas cooler 104. As relatively cooler air from the evaporator (arrow C) is passed over the gas cooler 104, the refrigerant is cooled and its temperature is lowered as heat is transferred to the air for supply to drum 26.

Upon exiting gas cooler 104, the refrigerant is fed by line 110 to an expansion device 113. Although only one expansion device 113 is shown, such is by way of example only—it being understood that multiple such devices may be used. Expansion device 113 lowers the pressure of the refrigerant and controls the amount of refrigerant that is allowed to enter the evaporator 116 by line 114. Importantly, the flow of liquid refrigerant into evaporator 116 is limited by expansion device 113 in order to keep the pressure low and allow expansion of the refrigerant back into the gas phase in the evaporator 116. The evaporation of the refrigerant in the evaporator 116 converts the refrigerant from its liquid-dominated phase to a gas phase while cooling the air (arrow E) from drum 26. The process is repeated as air is circulated through drum 26 and between evaporator 116 and gas cooler 104 while the refrigerant is cycled as just described.

Before operation of dryer 10, evaporator 116, gas cooler 104, and associated refrigerant are all at ambient temperatures. As dryer 10 is activated, a transient start-up period is initiated in which the evaporator 116 will initially cool to a lower temperature while gas cooler 104 will begin to warm as the refrigerant is cycled through the system by compressor 100. As operation continues and moves toward steady state operating conditions, the overall temperatures and pressures of the refrigerant in both the evaporator 116 and gas cooler 104 will increase and eventually reach operating conditions. However, the time needed to reach the desired operating conditions can unacceptably increase the overall drying cycle time.

Accordingly, evaporator 116 is equipped with a heating element 122 that raises the temperature of the evaporator and thereby increases the overall temperature and pressure of the refrigerant in heating system 40 more rapidly in order to reduce the overall drying cycle time. Heating element 122 can have a variety of configurations for applying heat directly to the evaporator 116. Preferably, heating element 122 is in close proximity to evaporator 116 and provides heat directly by conduction to the coils, tubes, or other construction of evaporator 116.

For example, heating element 122 can be an electrically resistive element or wire heater attached directly to evaporator 116. Alternatively, such a heating element could be sheathed in aluminum and attached to the coils or tubing of evaporator 116 during manufacture. Other constructions may also be used for applying heat directly to evaporator 116 by conduction from heating element 122 rather than convective heating of air in contact with heating element 122.

Providing heating element 122 in direct thermal contact with evaporator 116, heat can be applied to evaporator 116 to rapidly decrease the time over which refrigerant heating system 40 reaches steady state operating conditions after start-up. More specifically, heating element 122 operates to increase the thermal or energy content of refrigerant heating system 40 more rapidly than could be accomplished through compressor 100 alone or by only heating the air provided to evaporator 116 from drum 26 (arrow E). Accordingly, the user can be provided with a shorter overall drying cycle time and the efficiency of dryer 10 is increased.

Heating element 122 is controlled by a processing device 126 (such as e.g., a microprocessor), which may be used to also control other operations of dryer 10 as previously described. Processing device 126 is connected with a sensor 128 that measures the temperature and/or pressure of refrigerant in gas cooler 104. Using measurements received from sensor 128, processing device 126 can determine when refrigerant heating system 40 has reached steady state operating conditions or the desired operating state conditions. More particularly, processing device 126 can monitor sensor 128 and allow heating element 122 to add energy into refrigerant heating system 40 until a certain temperature and/or pressure set point is reached as determined using measurements from sensor 128. Upon reaching the set point, processing device can deactivate or otherwise regulate heating element 122.

Dryer 10 may be provided with an option whereby, through manipulation of e.g., knobs 70, the user can elect to by-pass the operating of heating element 122. More particularly, the use of heating element 122 can reduce the overall drying cycle time but may lead to increased energy usage depending upon e.g., the size of the load of articles in drum 26. If, for a particular load of articles, the user does not object to the longer cycle time, the user can elect to by-pass operating of the heating element. For example, a processing device or other controller can be configured to deactivate heating element 122 based on a user selection with knobs 70 or as instructed from an outside signal such as e.g., a signal from a smart grid enabled appliance. Similarly, the user could select reactivation of heating element 122 if a shorter cycle time is preferred.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A laundry dryer, comprising:
a drum for receipt of a load of articles for drying;
a refrigerant based heating system comprising
a compressor for pressurizing a refrigerant;
a gas cooler for cooling refrigerant from said compressor and heating air provided to said drum;
an evaporator for vaporizing refrigerant and cooling and dehumidifying air from said drum;
an expansion device for reducing the pressure of refrigerant received from said gas cooler; and,
a heating element attached to said evaporator, said heating element configured for raising the temperature of refrigerant flowing through said evaporator.

2. A laundry dryer as in claim 1, wherein said evaporator comprises coils for the flow through of refrigerant, and wherein said heating element comprises a wire heating element attached to the coils of said evaporator.

3. A laundry dryer as in claim 1, wherein said evaporator comprises coils for the flow through of refrigerant, and wherein said heating element comprises a wire heating element sheathed in a metal that is attached to the coils of said evaporator.

4. A laundry dryer as in claim 3, wherein said metal is comprised of aluminum.

5. A laundry dryer as in claim 1, further comprising a temperature sensor configured for monitoring the temperature of said gas cooler.

6. A laundry dryer as in claim 5, further comprising a processing device connected with said heating element and said temperature sensor, said processing device configured for controlling said heating element based on temperature measurements from said temperature sensor.

7. A laundry dryer as in claim 6, wherein said processing device is further configured to reduce or stop the addition of heat by said heating element once the laundry dryer reaches desired operating conditions as determined using measurements from said temperature sensor.

8. A laundry dryer as in claim 6, wherein said processing device is further configured to reduce or stop the addition of heat by said heating element once the temperature as reported by said temperature sensor reaches a certain predetermined temperature set-point.

9. A laundry dryer as in claim 1, further comprising a pressure sensor configured for monitoring the pressure of refrigerant flowing through said gas cooler.

10. A laundry dryer as in claim 9, further comprising a processing device connected with said heating element and said pressure sensor, said processing device configured for controlling said heating element based on pressure measurements from said pressure sensor.

11. A laundry dryer as in claim 10, wherein said processing device is further configured to reduce or stop the addition of heat by said heating element once the laundry dryer reaches steady state as determined using measurements from said pressure sensor.

12. A laundry dryer as in claim 10, wherein said processing device is further configured to reduce or stop the addition of heat by said heating element once the pressure of refrigerant in said gas cooler as reported by said pressure sensor reaches a certain predetermined pressure set-point.

13. A laundry dryer as in claim 1, further comprising a processing device connected with said heating element and configured for deactivation of said heating element based upon a selection by a user of the laundry dryer.

14. A method of operating a heat pump dryer, the heat pump dryer having a refrigerant cycle that includes an evaporator and a gas cooler through which a refrigerant is cycled, the method comprising the steps of:
applying heat to the evaporator using a heating element positioned to provide heat by thermal conduction to the evaporator;
raising the temperature, pressure, or both of the refrigerant using the heating element; and,
reducing or terminating the application of heat to the evaporator from the heating element once the temperature, pressure, or both of the refrigerant reaches a certain predetermined level.

15. A method of operating a heat pump dryer as in claim 14, wherein said predetermined level is a steady state condition of the heat pump dryer.

16. A method of operating a heat pump dryer as in claim 14, wherein said predetermined level is a predetermined set point for the temperature, pressure, or both.

17. A method of operating a heat pump dryer as in claim 14, wherein the heating element is a wire heater attached to the evaporator.

18. A method of operating a heat pump dryer as in claim 14, wherein the heating element is a wire heater sheathed in a metal that is attached to the evaporator.
